(19) United States
(12) Patent Application Publication
(10) Pub. No.: US 2025/0049254 A1
(43) Pub. Date: Feb. 13, 2025

(54) APPARATUS AND METHOD FOR PREPARING A SOLUTION FROM AN ACTIVE SUBSTANCE AND A SOLVENT AND FOR SUPPLYING THE SOLUTION TO A BEVERAGE PREPARATION MACHINE

(71) Applicant: EVERSYS S.A., Sierre (CH)

(72) Inventors: Thorsten SCHINDLER, Salgesch (CH); Jonathan BESSE, Chamoson (CH); Grégoire LOCHER, Daillon (CH); Sébastien ROBYR, Sierre (CH); David CONSTANTIN, Veyras (CH)

(73) Assignee: EVERSYS S.A., Sierre (CH)

(21) Appl. No.: 18/719,610

(22) PCT Filed: Dec. 14, 2022
(86) PCT No.: PCT/EP2022/085772

§ 371 Date: Jun. 13, 2024

(30) Foreign Application Priority Data
Dec. 16, 2021 (DE) 20 2021 106 869.8

(51) Int. Cl. A47J 31/60; A47J 31/40; A47J 31/46

(52) U.S. Cl. CPC A47J 31/60; A47J 31/401; A47J 31/404; A47J 31/461; A47J 31/469

(57) ABSTRACT

An apparatus for preparing a solution from an active substance and a solvent and supplying the solution to a beverage preparation machine, such as a coffee machine, includes a dissolving chamber for receiving the active substance, a supply element for supplying a quantity of the active substance to the chamber and a liquid line system coupled to the chamber and having a solvent line, which is connectable to a solvent supply for supplying the solvent. A discharge line is connected to the chamber and is connectable to the beverage preparation machine. To achieve a complete dissolution and an optimum concentration of the active substance in the solvent with a homogeneous concentration distribution over the volume of the solution, the apparatus has a piston unit which contains a first piston that can be introduced into the chamber, a second piston and a connecting line arranged between the first and second pistons.

### FIELD OF THE INVENTION

The invention relates to an apparatus for preparing a solution from an active substance and a solvent and for supplying the solution to a beverage preparation machine, and to a method for preparing an active substance solution and supplying the active substance solution to a beverage preparation machine.

### BACKGROUND

Cleaning devices integrated into beverage preparation machines, such as semi-automatic or fully automatic coffee machines, are known from the prior art for cleaning beverage preparation machines. The cleaning device is used in predefined cleaning cycles both during operation and after the beverage preparation machine has been switched off, in order, for example, to clean the coffee-and milk-carrying components of coffee and milk residues and of impurities, and in this way to keep the beverage preparation machine in perfect hygienic conditions at all times. The cleaning cycles can either be started manually by an operator or automatically by a control system of the beverage preparation machine.

Cleaning devices for the automatic cleaning of beverage preparation machines are known from the prior art, in which a cartridge with a cleaning agent inserted therein is used. Such a cleaning device is known, for example, from DE 10 2015 108 438 A1, in which a cartridge filled with a cleaning agent is connected to a liquid supply for hot beverage preparation in the beverage preparation machine in order to feed a liquid, in particular water, into the cartridge and to dissolve the solid cleaning agent contained in the cartridge. It can be ensured that an operator of the beverage preparation machine does not come into contact with the aggressive cleaning agent, as this is stored in a sealed manner in the cartridge. However, the dissolution of the cleaning agent in the cartridge in the liquid supplied to the cartridge is often incomplete because the water passed through the cartridge cannot completely convert the solid cleaning agent into a liquid cleaning agent solution. This makes it difficult to accurately meter an amount of detergent required to complete a cleaning cycle or a concentration of detergent required for this purpose in a detergent solution produced by dissolving the detergent in the liquid. Furthermore, cleaning devices with detergent cartridges have disadvantages from the point of view of waste avoidance, because the emptied cartridges, which regularly have a plastic housing, are intended for single use and must be disposed of.

Another device for cleaning a coffee machine having a water tank, a heating device, a brewing unit and a water line system with a feed pump for conveying water from the water tank through the water line system is known from DE 10 2011 054 601 A1, wherein the cleaning device comprises a chamber for a descaling and/or cleaning agent, which chamber is connectable or connected to the water line system so that water from the water tank can be conveyed through the chamber into the water line system of the coffee machine by means of the feed pump of the coffee machine. This cleaning device is intended to allow complete dissolution and mixing of the descaling and/or cleaning agent, in that the agent located in the chamber is dissolved in an aqueous solution by introduction and by transport of water through the chamber, and the aqueous solution is conveyed from the chamber into the water line system of the coffee machine, in particular in order to clean the brewing unit and/or the heating device with the cleaning agent solution. Even with this device, however, it is difficult to precisely meter the amount of cleaning agent required for a cleaning process or the concentration of the cleaning agent in the cleaning agent solution.

For the precise metering of a specific quantity of a cleaning agent required for carrying out a cleaning process in a beverage preparation machine, cleaning devices with a metering device for the cleaning agent are known from the prior art, wherein a solid cleaning agent, for example in powder, granulate, solid or tablet form, is fed to the metering device. From EP 1 210 894 B1, for example, a beverage machine, in particular a coffee machine, with a feed device for solid cleaning agent, in particular in pressed-body form, is known, in which an automatically metering, self-contained metering device for the cleaning agent is provided. The dosing device comprises a storage container for the solid cleaning agent and a dosing unit with a movable dosing chamber through which a predetermined quantity of the cleaning agent can be conveyed from the storage container into an outlet.

A further cleaning system for an automatic beverage dispenser, in particular a coffee machine, is known from EP 2 584 946 B1, wherein the cleaning system includes a cleaning device for periodic cleaning of the components coming into contact with the beverages by means of a cleaning liquid. To produce the cleaning liquid, a solid cleaning agent, which may in particular be in spherical or tablet form, is dissolved in the cleaning liquid in the cleaning device. The cleaning device comprises a controlled metering device with a metering barrier, which releases the cleaning balls or tablets, which are stored in a storage container, into a discharge chute with a metering opening. Two counter-rotating metering screws are arranged between the storage container and the discharge chute, through which the cleaning balls or tablets can be conveyed individually into the discharge chute.

Cleaning devices known from the prior art with a metering device for the metered supply of a solid cleaning agent enable, on the one hand, simple and safe handling of the cleaning agent and, on the other hand, a precise metering of the quantity of cleaning agent required for a cleaning process and a precisely metered active substance concentration of the cleaning agent in a cleaning liquid produced by dissolving the solid cleaning agent.

In beverage preparation machines, besides cleaning solutions, other types of solutions of an active substance in a solvent are also required, such as descaling solutions, solutions of aroma or flavoring substances, solutions of powders or granules, such as milk, sugar or chocolate powder in liquid solvents such as water or milk. There is therefore a further need for an apparatus for preparing a solution of an active substance and a solvent and for supplying the solution to a beverage preparation machine, which ensures homogeneous mixing or complete dissolution of the active substance in the solvent with an accurate active substance concentration and safe supply of the solution to the beverage preparation machine.

Based on this, there is a need for an apparatus for producing a solution from an active substance and a solvent and for supplying the produced solution to a beverage preparation machine, which enables complete dissolution of the active substance, which is supplied, for example, in powder or tablet form by means of a metering device, in the solvent in order to produce an optimum concentration of the active substance in the solution with a homogeneous concentration distribution over the volume of a dose of the solution. In particular, a complete dissolution or a homogeneous mixing of the active substance in the solution shall be achieved. Furthermore, the consumption of active substance shall be minimized. The apparatus is to be controllable fully automatically by a control device of the beverage preparation machines in order to be able to carry out, for example, fully automatically, pre-programmed cleaning cycles or production cycles for the production of beverages with an exact dosage of the amount of active substance required for the cleaning or production cycle with an optimum active substance concentration in the solution in a dose of the solution required for the cleaning or production cycle.

### SUMMARY OF THE INVENTION

One aspect of the invention therefore is the provision of such an apparatus for producing a solution from an active substance and a solvent and for feeding the solution to a beverage preparation machine, with which different solutions from different active substances and solvents can be produced and transferred to a beverage preparation machine. The active substance should be available in solid form, for example in powder or tablet form, or in liquid form, and it should be possible to use different solvents in liquid form, in particular water or milk, to produce the solution. In particular, a complete dissolution as well as an optimal concentration of the active substance in the solvent with a homogeneous concentration distribution over the volume of the solution should be achieved. The apparatus is to be controllable fully automatically by a control device of the beverage preparation machines in order, for example, to be able to carry out pre-programmed processes, such as cleaning or descaling processes or processes for preparing beverages, fully automatically with an exact concentration of the active substance and the amount of solution required for the respective process.

These tasks are solved with the apparatus for preparing a solution from an active substance and a solvent and for supplying the solution to a beverage preparation machine as well as with the method for supplying an active substance solution to a beverage preparation machine as disclosed herein. Furthermore, a beverage preparation machine equipped with an apparatus according to the invention contributes to the solution of the problem. Preferred embodiments of the apparatus, of the beverage preparation machine equipped with the apparatus, and of the method are also disclosed herein.

The apparatus according to the invention comprises a dissolving chamber for receiving an active substance and a fluid line system coupled to the dissolving chamber and comprising a solvent line connectable to a solvent supply for supplying the solvent and a discharge line connected to the dissolving chamber and connectable to the beverage preparation machine, wherein a piston unit comprising a first piston insertable into the dissolving chamber, a second piston, and a connecting line arranged between the first piston and the second piston is provided.

Through the solvent line, the liquid solvent, which is in particular water, milk or alcohol, can be fed into the dissolving chamber in order to dissolve a predetermined amount of the active substance in an active substance solution located therein. In this regard, the first piston insertable into the dissolving chamber enables good and homogeneous mixing of the active substance in the active substance solution, and the piston also closes an active substance access into the first chamber through which the active substance is supplied when the piston is inserted into the dissolving chamber in an operating position. When the first piston is in its operating position in the dissolving chamber, the solvent can be introduced into the dissolving chamber via the solvent line to dissolve the amount of active substance in the active substance solution located in the chamber. For this purpose, the first piston is preferably movably arranged in the dissolving chamber between an upper base position, in which the first piston is pulled out of the dissolving chamber, and the lower operating position, in which the first piston is located in the dissolving chamber. This enables, on the one hand, a complete dissolution and a homogeneous mixing of the active substance in the active substance solution as well as a homogeneous concentration of the active substance in a predetermined volume of the active substance solution and, on the other hand, ensures that no further active substance can enter the chamber during dissolution or mixing of the active substance, because the active substance access of the chamber is closed by the piston inserted into the dissolving chamber.

The active substance may be, for example, a cleaning or descaling agent or ingredients for beverages such as sugar, syrup or other concentrates, milk or chocolate powder, aroma or flavoring agents, or beverages containing alcohol.

According to the invention, the first piston is part of a piston unit, which comprises the first piston, a second piston and a connecting line arranged between the first piston and the second piston and connecting the two pistons. In this case, the second piston is preferably arranged movably in a front chamber, the front chamber being arranged upstream of the dissolving chamber, as seen in the direction of flow of the solvent supplied via the solvent line, and being connected to the dissolving chamber in a fluid-conducting manner via the connecting line. Via the connecting line, a movement of the second piston in the front chamber is transmitted to the first piston. The solvent line is thereby preferably connected to an inlet connection piece of the front chamber. This arrangement enables an automatic movement of the first piston and the second piston connected thereto via the connecting line in the dissolving chamber and the front chamber, respectively, when solvent is introduced into the front chamber through the solvent line. The pressure of the introduced solvent moves the second piston in the front chamber from a base position to an operating position, in particular from top to bottom, and the first piston thereby also moves to its operating position, while the solvent can flow through the connecting line from the front chamber into the dissolving chamber to fill the dissolving chamber with solvent and dissolve the amount of active substance therein in the solvent or mix it with the solvent to produce an active substance solution.

To preload the piston unit, it preferably comprises a spring element which preloads the second piston in the front chamber in its base position. When solvent is introduced into the front chamber, the spring element is compressed by the pressure of the solvent flow against its restoring force, as a result of which the second piston and the first piston are brought into their respective operating positions. The spring element is expediently arranged between the first piston and the second piston and, in particular, around the tubular connecting line, and the spring element is preferably supported on a support in the front chamber. The support is preferably arranged in an end region of the front chamber, in particular at a bottom of the front chamber, the spring element extending between the support and an end face, in particular the lower end face, of the second piston. Due to this arrangement, the spring element exerts a preload on the first and second pistons in an unloaded state, which holds the first and second pistons in their respective base positions, the first piston being pulled out of the dissolving chamber in its base position and the second piston being located in its base position within the front chamber in an (upper) limit position, in which the second piston bears against an (upper) stop of the front chamber.

In order to ensure a safe movement of the first piston into its operating position when solvent is introduced through the solvent line and in order to hold the first piston in this operating position during the introduction of solvent, the front chamber preferably has a larger cross-section and in particular a larger diameter than the dissolving chamber and, correspondingly, the second piston also preferably has a larger cross-section and in particular a larger diameter than the first piston. Due to the larger cross-section of the first piston compared to the cross-section of the second piston, the counterforce exerted by the solvent introduced into the dissolving chamber on the first piston, in particular on its lower end face, is smaller than the force exerted by the pressure of the solvent flow on the second piston, in particular on its upper end face, as a result of which the first and second pistons are each held in their operating position as long as solvent is introduced via the solvent line.

Preferably, at least one valve, in particular a shut-off valve and/or a control valve, in particular a pressure control valve, and/or a pressure reducer is arranged in the solvent line. The arrangement of a shut-off valve enables the solvent line to be opened and closed, thereby allowing solvent to be introduced into the apparatus and the solvent supply to be stopped. The arrangement of a pressure regulating valve and/or a pressure reducer in the solvent line makes it possible to set a predetermined pressure of the solvent flow, which is preferably in the range of 3 to 10 bar.

For sealing the first chamber and the front chamber, the first piston and the second piston preferably each have at least one sealing element, the sealing element of the first piston bearing sealingly against an inner wall of the dissolving chamber and the sealing element of the second piston bearing sealingly against an inner wall of the front chamber.

For the supply of a predetermined amount of active substance, the dissolving chamber preferably has at least one active substance access, the active substance access being expediently arranged in an upper region or at an upper end of the dissolving chamber. The or each active substance access comprises an opening in a wall of the dissolving chamber, through which the active substance, which is present for example in the form of tablets or spheres or also as granules, powder or liquid, can be introduced into the dissolving chamber.

Preferably, in its operating position, the first piston is located in the dissolving chamber to such an extent that access of the active substance to the dissolving chamber is blocked. This ensures that no further active substance can be introduced into the dissolving chamber during the introduction of solvent into the dissolving chamber, thereby ensuring exact metering of the active substance quantity in the dissolving chamber and precise concentration of the active substance in the active substance solution.

The active substance access is expediently coupled to a dispenser or a dosing device in order to dose a predetermined amount of the active substance through the active substance access into the dissolving chamber. The dispenser or dosing device is preferably a dispenser with which a solid active substance, for example in the form of spheres or tablets, which are stored in a storage container, can be fed individually to the active substance access. Such a dosing device is known, for example, from EP 2 584 946 B1. This ensures exact metering of the amount of active substance introduced into the dissolving chamber via the active substance access. It is possible, for example, to introduce a predefinable number of active substance spheres or tablets into the dissolving chamber, so that different concentrations of the active substance can be produced in a dose of the active substance solution predetermined by the available volume of the dissolving chamber via the number of spheres or tablets.

For discharging the active substance solution generated in the dissolving chamber into a discharge line connected to the liquid line system of the beverage preparation machine, the apparatus preferably comprises a compressed gas line which can be coupled to a compressed gas source. Preferably, the front chamber is connected to the pressurized gas line for this purpose, with the pressurized gas line expediently opening into the front chamber in an upper section or at an upper side. Alternatively, the compressed gas line can also open into the solvent line. Via the compressed gas line, after the solvent supply has ended and preferably after complete dissolution of the active substance in the active substance solution, a compressed gas (pressurised gas), for example compressed air, can be introduced into the apparatus and, in particular, into the front chamber and, via the connecting line, into the dissolving chamber, in order to force the active substance solution generated in the dissolving chamber into the discharge line connected to the dissolving chamber.

A shut-off valve and/or a control valve is preferably arranged in the discharge line in order to open and close the discharge line or to be able to set a specific flow cross-section in the discharge line. The volume flow of the active substance solution discharged and/or the pressure in the dissolving chamber can be adjusted via a control valve arranged in the discharge line.

The apparatus can be operated in a continuous mode or in a batch mode, depending on the position of the shut-off or control valve in the discharge line. In continuous operation, the stop or control valve in the discharge line is at least partially open while solvent is continuously passed through the dissolving chamber, whereby the active substance in the dissolving chamber is dissolved or mixed in an active substance solution and the active substance solution is directly and continuously discharged through the open discharge line to the beverage preparation machine. In this case, the use of a control valve in the discharge line is advantageous because the flow cross-section in the discharge line can be adjusted by the position of the control valve. By changing the flow cross-section in the discharge line, the volumetric flow rate of the active substance solution and the concentration of the active substance in the active substance solution can be adjusted. A nozzle arranged in the connecting line ensures that the piston unit, and in particular the first piston, is held in a predetermined operating position, regardless of the position of the control valve in the outflow line.

In batch operation, the shut-off or control valve in the discharge line is closed, while solvent is fed into the dissolving chamber at a predetermined pressure via the solvent line. To set a specific pressure of the solvent flow, a pressure control valve and/or a pressure reducer is preferably arranged in the solvent line. Via the pressure of the solvent flow; the exact position of the first piston in the dissolving chamber can be set in the batch operation of the apparatus with the discharge line closed in the operating position. The position of the first piston in the operating position thereby determines the volume in the first chamber in which the active substance solution is generated by dissolving or mixing the active substance. The position of the first piston in the operating position therefore determines the volume of a dose of the active substance solution provided by the apparatus for performing an operation in the beverage preparation machine. After completion of the dissolving or mixing of the active substance in the active substance solution, the water supply is stopped by closing the shut-off or control valve in the discharge line, and the dose of the active substance solution located in the dissolving chamber is supplied to the beverage preparation machine by introducing a compressed gas, for example compressed air, into the dissolving chamber while the valve in the discharge line is open. The volume flow of the active substance solution supplied to the beverage preparation machine can be adjusted by the position of a control valve arranged in the discharge line.

To control an operation in the beverage preparation machine, e.g. a cleaning operation, the apparatus is preferably coupled to a control device of the beverage preparation machine, which automatically initiates an operation, e.g. a cleaning or descaling operation or the production of a beverage selected by the operator, at predetermined times and/or events, e.g. when the beverage preparation machine is switched on or off, after a beverage selection by an operator or after a predetermined number of beverage withdrawals. In this context, various such processes can also be set or programmed in the control device, each process preferably being assigned a specific dosage and/or concentration of the active substance solution required for carrying out the process in the beverage preparation machine. Preferably, the control device is programmable so that an operator can set specific operations and cycles individually according to his needs or depending on the beverages produced by the beverage preparation machine.

To control the device, the valves arranged in the solvent line and in the discharge line are coupled to the control device. This means that the solvent line and the discharge line can be opened and closed or a specific pressure of the solvent flow in the solvent line and/or a specific volume flow of the active substance solution can be set by the control device when it is fed to the beverage preparation machine. Furthermore, the control device is preferably also coupled to the pressurized gas source and/or a valve in the pressurized gas line to control the supply of the pressurized gas. If the active substance inlet is coupled to a dispenser or a dosing device, the dispenser or the dosing device is expediently also controlled by the control device.

Particularly rapid and complete dissolution of solid active substance in the active substance solution can be achieved, when the dissolving chamber is supplied with warm or hot solvent in which the solid active substance dissolves. Therefore, the solvent line is preferably coupled to a solvent supply that provides heated solvent, in particular having a temperature between 40° C. and 100° C. The solvent supply is thereby expediently coupled to a boiler or a continuous flow heater of the beverage preparation machine, which generates, for example, hot water or hot milk for the beverage preparation. In a preferred embodiment, the front chamber is connected via the solvent line to the boiler or the flow heater, which provides heated solvent at a temperature of at least 40° C. The solvent supply is connected to the boiler or flow heater via the solvent line.

In the method according to the invention for supplying an active substance solution to a beverage preparation machine, which is in particular a beverage preparation machine equipped with an apparatus according to the invention, a solution of an active substance and a solvent is first prepared in a dissolving chamber, in that a specific quantity of an active substance is metered into the dissolving chamber and then a solvent is fed into the dissolving chamber via a solvent line which can be connected to a solvent supply, as a result of which the active substance is dissolved in the solvent to form an active substance solution, and then the active substance solution is fed to the beverage preparation machine via a discharge line connected to the dissolving chamber. In this method, according to the invention, after the active substance has been metered into the dissolving chamber, a first piston is introduced into the dissolving chamber and is pressed into the dissolving chamber by a pressure generated by the introduced solvent.

Preferably, the solvent fed into the dissolving chamber has a temperature of at least 40° C. preferably of more than 60° C., and in particular between 60° C. and 100° C. This improves the efficiency of the dissolving process in the dissolving chamber. Furthermore, the solvent introduced into the dissolving chamber preferably has a pressure of at least 3 bar, preferably between 3 bar and 10 bar and in particular between 4 bar and 6 bar. Due to this pressure of the introduced solvent, the first piston is pressed into the dissolving chamber and held therein in an operating position as long as solvent is supplied at the predetermined pressure.

To carry out the process, the dissolving chamber is preferably fluidically coupled to a front chamber, the solvent line carrying the solvent being connected to the front chamber in order to feed the solvent into the front chamber and into the dissolving chamber. The first piston is thereby connected to a second piston via a connecting line, wherein the second piston is movably arranged in the front chamber. In this case, the solvent is introduced into the dissolving chamber after a metering of a specific amount of the active substance, the first piston being introduced into the dissolving chamber and held in its operating position during the solvent supply. The incoming solvent thereby first presses the second piston into the front chamber and the pressure generated by the introduced solvent is transferred from the second piston to the first piston, bringing the first piston in the dissolving chamber into its operating position. Thereby, after the first piston has been introduced into its operating position, the solvent flows into the first chamber through the connecting line connecting the first and second pistons. The connecting line, which is in particular tubular, preferably extends through the first and second pistons in order to establish a fluidic connection between the dissolving chamber and the front chamber.

When solvent is supplied through the solvent line, the first piston is thus pressed into the dissolving chamber by the pressure generated by the solvent stream introduced, the pressure generated by the introduced solvent first acting on the second piston, in particular its upper end face, and being transmitted by the latter to the first piston. In this case, the cross-section of the second piston, on which the pressure of the solvent flow acts, is preferably larger than the cross-section of the first piston, on which a counterpressure acts that is generated by the solvent flowing into the dissolving chamber via the connecting line.

After the active substance solution has been generated by dissolving or mixing the active substance in the solvent that has been supplied to the dissolving chamber, the supply of solvent is first stopped and then the active substance solution is forced from the dissolving chamber into the discharge line by introducing a compressed gas, in particular compressed air, into the dissolving chamber and is thereby supplied to the beverage preparation machine. In continuous operation, the active substance solution generated in the dissolving chamber can also be fed into the discharege line while the solvent is still being fed in.

As soon as the active substance solution has been completely transferred to the discharge line, the introduction of the pressurized gas into the dissolving chamber is stopped, causing the second piston to move out of the dissolving chamber automatically to its base position due to the restoring force of a spring element.

When the first piston is in its base position outside the dissolving chamber, the active substance access through which the active substance is introduced into the dissolving chamber is unblocked, and the active substance access is blocked when the first piston is in an operating position inside the dissolving chamber. This prevents active substance from still entering the dissolving chamber during the generation of the active substance solution.

The method is preferably controlled automatically by a control device which, in particular, controls a valve in the solvent line and/or a solvent supply connected thereto, a dispenser or dosing device for dispensing the determined amount of the active substance, a compressed gas source for introducing a compressed gas into the dissolving chamber, and a valve in the discharge line, in order to carry out the steps described above for preparing an active substance solution and supplying the active substance solution to a beverage preparation machine.

In this context, the control device is preferably set up or programmable in such a way that an operation of the beverage preparation machine is automatically executed after predetermined events, which are in particular dependent on an operation of the beverage preparation machine, and/or after a selection of an operator via a communication interface of the beverage preparation machine or at predetermined times, wherein in the operation, the active substance solution produced can be used in the beverage preparation machine, for example, to produce a beverage or to carry out a cleaning or descaling operation.

Furthermore, it is an aspect of the invention to provide a beverage preparation machine, in particular a coffee machine, in which hot milk as well as warm or cold milk foam can preferably also be prepared via an integrated milk module, wherein the beverage preparation machine is equipped with an apparatus according to the invention. Preferably, an apparatus according to the invention is integrated into the beverage preparation machine or can be inserted as a replaceable module. In this case, the apparatus is expediently coupled to a brewing device for brewing a hot beverage and/or to a milk module for heating and/or foaming milk, as well as to a line system, in order to be able to supply a generated active substance solution to the brewing device and/or to the milk module, as well as to the lines of the line system in which the beverages and beverage ingredients are transported.

### BRIEF DESCRIPTION OF THE DRAWINGS

These and other advantages, applications as well as features of the invention result from the example embodiments described below with reference to the drawings. These show:

FIG. 1: A schematic representation of a first embodiment of an apparatus according to the invention in a base position:

FIGS. 2A-2D: Schematic representations of the apparatus of FIG. 1 in various positions during the initiation and execution of a cycle for the preparation and transfer of an active substance solution to a beverage preparation machine, wherein FIG. 2A shows the apparatus in the base position, in which an active substance is supplied, FIG. 2B shows the apparatus in an operating position, in which a solvent is supplied and the active substance is dissolved therein to form an active substance solution, FIG. 2C shows the apparatus in the operating position in which the active substance solution is discharged, and FIG. 2D shows the apparatus again in the base position in which it is ready to receive the active substance for a subsequent cycle:

FIG. 3: A schematic representation of a second embodiment of an apparatus according to the invention in a base position.

### DETAILED DESCRIPTION

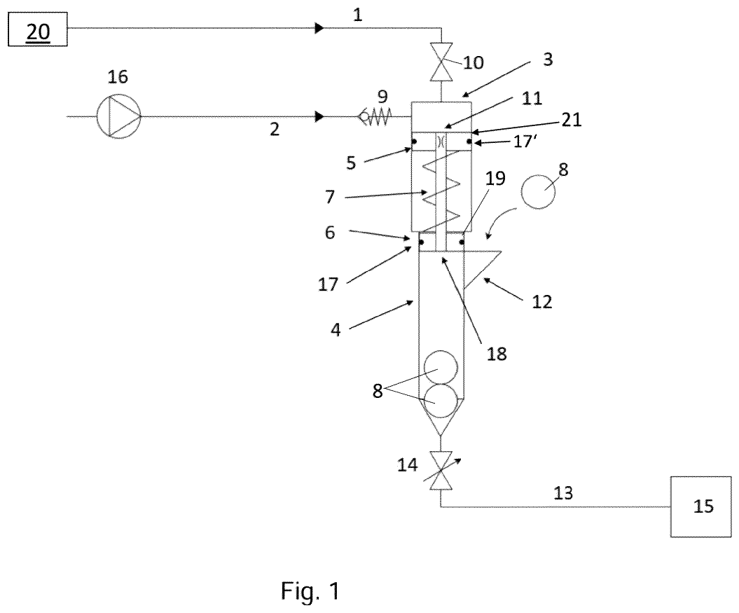

The apparatus shown in FIG. 1 comprises a dissolving chamber 4 with a first piston 6 movably arranged therein and a front chamber 3 with a second piston 5 movably arranged therein. The dissolving chamber 4 and the front chamber 3 are of hollow cylindrical design and each have a cylindrical wall. The dissolving chamber 4 extends in a vertical direction from an open upper end to a lower end, which is funnel-shaped and opens into a discharge line 13 connected to the dissolving chamber 4. The first piston 6 can be inserted into the dissolving chamber 4 through the open upper end. The front chamber 3 is arranged above the dissolving chamber 4 and also extends between an upper end and a lower end, the lower end having a bottom with a central opening. At the upper end of the front chamber 3, an inlet nozzle is arranged to which a solvent line 1 is connected. The solvent line 1 is part of a liquid line system of the apparatus, which includes the solvent line 1 and the discharge line 13. The solvent line 1 is connected to a solvent supply 20 that provides a solvent, for example water. The solvent may be heated and preferably has a temperature of at least 40° C. and in particular in the range between 60° C. and 100° C. Heating the solvent is advantageous, for example, if a cleaning agent solution is to be produced from the solvent, since its effect is improved at a higher temperature. In addition, the efficiency of the dissolving process improves at these temperatures. A shut-off valve 10 is arranged in the solvent line 1, which serves to open and close the solvent line 1. Instead of or in addition to a shut-off valve, a control valve and/or a pressure reducer can also be arranged in the solvent line 1.

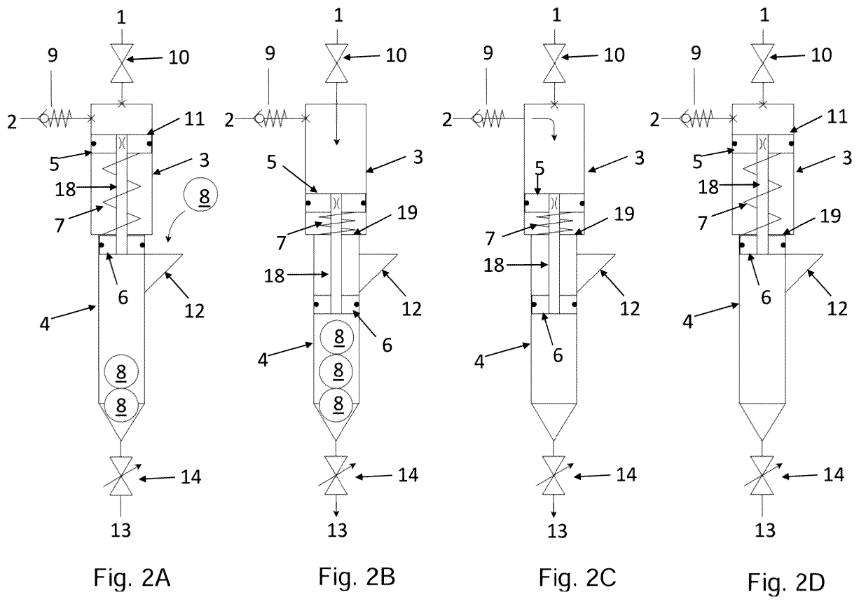

In the region of the upper end of the front chamber 3, a stop 21 is arranged which can be formed, for example, by an annular flange projecting from the wall of the front chamber 3 into the interior of the chamber. The second piston 5 movably arranged in the front chamber 3 can move in the front chamber 3 between a base position a and an operating position b, wherein an upper side of the second piston 5 in the base position a shown in FIG. 1 rests against the stop 21 and a lower side of the second piston 5 in the operating position b shown in FIG. 2B rests on the bottom of the front chamber 3 or is at least located near the bottom.

As can be seen from FIG. 1, the front chamber 3 has a larger cross-section and, in particular, a larger diameter than the dissolving chamber 4. Accordingly, the second piston 5 also has a larger cross-section and in particular a larger diameter than the first piston 6.

The first piston 6 and the second piston 5 are each cylindrical or disc-shaped and are connected to one another via a connecting line 18, the connecting line 18 extending through both the first piston 6 and the second piston 5 and passing through the central opening in the bottom of the front chamber 3. The connecting line 18 thereby provides a fluid connection between the dissolving chamber 4 and the front chamber 3. A nozzle 11 is preferably arranged in the connecting line 18.

A spring element 7 is arranged in the front chamber 3, for example a spiral spring, which extends between the underside of the second piston 5 and the bottom of the front chamber 3. The spring element 7 is arranged in particular around the connecting line 18, as can be seen in FIG. 1. The bottom of the front chamber 3 forms a support 19 on which the spring element 7 is supported. The second piston 5 in the front chamber 3 is preloaded in its (upper) base position a by the spring element 7. Accordingly, the first piston 6, which is connected to the second piston 5 via the connecting line 18, is also in an (upper) base position a, in which the first piston 6 is pulled out of the dissolving chamber 4.

The first piston 6 and the second piston 5 each have at least one circumferential sealing ring 17, 17′ on their outer circumference, the sealing ring 17 of the first piston 6 is bearing against the inside of the wall of the dissolving chamber 4 and the sealing ring 17′ of the second piston 5 is bearing against the inside of the wall of the front chamber 3 when the second piston 5 is moved in the front chamber 3 from its (upper) base position a into its (lower) operating position b and the first piston 6 simultaneously is moving into the dissolving chamber 4.

The first piston 6 and the second piston 5 as well as the connecting line 18 and the spring element 7 form a piston unit which is preloaded in a base position a by the spring element 7 and can be moved from the base position a to an operating position b by applying an external force.

An active substance access 12 is arranged in the region of the upper end of the dissolving chamber 4. The active substance access 12 comprises a lateral opening in the wall of the dissolving chamber 4, not shown here, through which an active substance 8, for example in tablet or ball form, can be introduced into the dissolving chamber 4. In order to dose the active substance 8 in a predetermined amount into the dissolving chamber 4, the active substance access 12 is connected to a dispenser or a dosing device which doses the active substance 8 through the active substance access 12 into the dissolving chamber 4. Preferably, the active substance 8 is in the form of tablets or spheres, which are individually dosed into the dissolving chamber 4 by means of the dispenser or the dosing device. Several tablets or spheres of the active substance 8 can also be introduced into the dissolving chamber 4 via the active substance access 12, as indicated in FIG. 1 by the two active substance spheres 8, which are located at the lower, funnel-shaped end of the dissolving chamber 4. However, the active substance can also be in the form of powder, granules or a liquid.

In the region of the upper end, a compressed gas line 2 opens into the front chamber 3. The compressed gas line 2 contains a check valve 9 and is connected upstream of the check valve 9 to a compressed gas source 16 which provides a compressed gas, for example compressed air. Instead of compressed air, other food-grade gases can also be provided under pressure by the compressed gas source 16. For this purpose, compressed nitrogen gas or compressed carbon dioxide, for example, may also be considered instead of compressed air. The compressed gas source 16 can be formed, for example, by a compressor that draws in ambient air and compresses it to a predetermined pressure.

The discharge line 13 connected to the lower end of the front chamber 4 is coupled to a beverage preparation machine 15 and, in particular, is connected to a liquid line system of the beverage preparation machine 15 in order to conduct an active substance solution generated in the apparatus into the liquid line system of the beverage preparation machine 15. At least one valve is disposed in the discharge line 13 for opening and closing the discharge line 13. Preferably, the discharge line 13 includes a control valve 14 having an adjustable flow cross-section.

The apparatuse shown in FIG. 1 is expediently arranged in a housing of the beverage preparation machine 15. Preferably, the apparatus is inserted as an exchangeable module in the housing of the beverage preparation machine 15. The solvent supply 20 and the compressed gas source 16 are thereby preferably components of the beverage preparation machine 15, which on the one hand can be used in the production of beverages in the beverage preparation machine, for example for the provision of hot water or of heated milk and for the provision of compressed gas, in particular compressed air, and on the other hand can supply the apparatus with solvent via the solvent line 1 and with a compressed gas via the compressed gas line 2. The solvent supply 20 can thereby be formed in particular by a boiler or a continuous flow heater of the beverage preparation machine 15, which provides heated water.

A control device is provided for controlling the apparatus, which controls in particular the valves 10 and 14 in the solvent line 1 and in the discharge line 13, as well as the supply of a compressed gas from the compressed gas source 16 through the compressed gas line 2 and the introduction of the active substance 8 through the active substance access 12 into the dissolving chamber 4. The control device can thereby expediently be a component of the control device of the beverage preparation machine 15, which is set up in such a way that after or at certain times or events, which depend in particular on the production of beverages in the beverage preparation machine 15 and can be selected, for example, by an operator via a communication interface, a process is initiated in the beverage preparation machine 15 for which the beverage preparation machine 15 requires an active substance solution produced in the apparatus.

In FIGS. 2A-2D, individual phases of a cycle for producing a solution from the active substance and the solvent, which can be carried out with the apparatus of FIG. 1, are shown by different positions of the apparatus, wherein the phases shown in FIGS. 2A-2D are carried out successively in the cycle in order to produce an active substance solution in the apparatus in a continuous operation or in a batch operation and to pass it to a beverage preparation machine.

In FIG. 2A, the apparatus is shown in its base position a, which corresponds to the representation of FIG. 1. To initiate a cycle for producing a solution from an active substance and a solvent. with the compressed gas source 16 shut off or the compressed gas line 2 closed and valves 10 and 14 closed, a predetermined amount of active substance 8, e.g. a certain number of active substance tablets or beads, is first added to the dissolving chamber 4 through the active substance access 12. Then, as shown in FIG. 2B, the valve 10 in the solvent line 1 is opened. Furthermore, the control valve 14 in the discharge line 13 is at least partially opened and, in particular, set to a predetermined flow cross-section. As a result, warm solvent, for example water with a temperature of 40° C. to 80° C., and with a predetermined pressure of the solvent flow, which is preferably more than 3 bar and in particular between 3 bar and 10 bar, preferably flows from the solvent line 1 into the upper area of the front chamber 3. The pressure of the solvent flow can thereby be set to a specific value by a pressure regulating valve or a pressure reducer in the solvent line 1, if necessary. As a result of the pressure of the solvent flow acting on the upper end face of the second piston 5, the second piston 5 in the front chamber 3 is moved from its base position a shown in FIG. 2A into the operating position b shown in FIG. 2B, in which the second piston 5 in the front chamber 3 is located near the bottom. Since the second piston 5 is coupled to the first piston 6 via the connecting line 18, the first piston 6 thereby also moves from its base position a shown in FIG. 2A, in which the first piston 6 is pulled out of the dissolving chamber 4, to the operating position b shown in FIG. 2B, in which the first piston 6 is located within the dissolving chamber 4 at a certain height. The first piston 6 is thereby arranged above the balls of the active substance 8 located in the dissolving chamber 4, as shown in FIG. 2B. The movement of the first piston 6 into its operating position b shown in FIG. 2B closes the active substance access 12 and in particular the opening in the wall of the dissolving chamber 4, so that no more active substance can enter the dissolving chamber 4 in an area below the first piston 6.

The solvent flowing into the front chamber 3 via the solvent line 1 flows through the nozzle 11 in the connecting line 18 into the dissolving chamber 4, which is connected to the front chamber 3 via the connecting line 18 in a fluid-conducting manner. Due to the larger cross-section of the first piston 6 compared to the cross-section of the second piston 5, the counterforce exerted on the first piston 6 by the solvent introduced into the dissolving chamber 4 is smaller than the force exerted on the second piston 5 by the pressure of the solvent flow, as a result of which the first piston 6 and the second piston 5 are each held in their operating position b as long as the pressurized solvent is introduced via the solvent line 1. The nozzle 11 thereby ensures a sufficiently high pressure upstream of the nozzle 11 to keep the piston unit in its operating position b.

As a result of the inflow of solvent into the dissolving chamber 4 in the area below the first piston 6, the balls of the active substance 8 located in the dissolving chamber 4 are dissolved in the solvent to form an active substance solution. The concentration of the active substance 8 in the active substance solution is determined by the amount of active substance in the dissolving chamber 4 and the volume flow of the solvent flowing through, which depends on the set flow cross-section in the discharge line 13.

The closed active substance access 12 ensures that no further active substance can be added to the active substance solution in the dissolution chamber 4 during dissolution of the active substance 8.

Thus, for a given flow cross-section in the discharge line 13 and a given amount of the active substance 8 in the dissolving chamber 4, a given active substance concentration is established in the active substance solution, which flows continuously into the discharge line 13 and is thereby conveyed to the beverage preparation machine 15, in particular into the liquid line system of the beverage preparation machine 15.

The temperature and pressure of the solvent flow introduced into the dissolving chamber 4 ensure complete dissolution and homogeneous mixing of the active substance 8 in the active substance solution. After transfer of a sufficient quantity of the active substance solution for the operation to be carried out in the beverage preparation machine, the valve 10 of the solvent line 1 is closed, thereby stopping the solvent supply. Then-as shown in FIG. 2C—a compressed gas, in particular compressed air, is introduced via the compressed gas line 2 into the upper region of the front chamber 3, the pressure of the compressed gas preferably being more than 1 bar and in particular between 1.5 bar and 3 bar. The pressure of the introduced compressed gas, which flows from the front chamber 3 via the connecting line 18 into the dissolving chamber 4, forces a residual amount of the active substance solution still in the dissolving chamber 4 into the discharge line 13.

Instead of the continuous operation described above, the apparatus can also be operated in a batch mode, in which a certain dose of an active substance solution with a certain concentration of the active substance is first generated in the dissolving chamber and then supplied to the beverage preparation machine 15 through the discharge line 13. In this batch operation, the volume of a dose of the generated active substance solution is determined by the position of the first piston 6 in the first chamber 4 in its operating position b, because this position determines the volume of the dissolving chamber 4 below the first piston 6 in which the active substance 8 is located. The position of the first piston 6 in the dissolving chamber 4 in its operating position can thereby be adjusted by the pressure of the solvent flow introduced via the solvent line 1 when the discharge line 13 is closed. Thus, the volume of the dose of the active substance solution in the dissolving chamber 4 can be varied by the pressure of the solvent flow. Therefore, when the active substance 8 is dissolved or mixed in the solvent, a certain concentration of the active substance 8 in the formed active substance solution results, which is determined by the predetermined amount of the active substance 8 in the dissolving chamber 4 and the volume of the dissolving chamber 4 below the first piston 6.

After dissolving and mixing the active substance 8 in the dose of the solvent located in the dissolving chamber 4, the generated dose of the active substance solution is supplied to the beverage preparation machine 15 via the discharge line 13 by opening the discharge line 13, and in particular the valve 14, with the valve 10 in the solvent line 1 being closed and introducing a compressed gas into the dissolving chamber 4 by means of the compressed gas line 2. In this case, the dose of the active substance solution has a certain concentration of the active substance in the solution, wherein the concentration can be adjusted by the amount of the active substance 8 supplied to the dissolving chamber 4 and the pressure of the solvent flow during the preparation of the active substance solution. A control valve 14 arranged in the discharge line 13 advantageously enables the setting of a specific volume flow of the active substance solution from the dissolving chamber 4 into the discharge line 13 when the active substance solution is discharged.

After transfer of the active substance solution from the dissolving chamber 4 into the liquid line system of the beverage preparation machine 15 in a continuous operation or a batch operation of the apparatus, the cycle is ended and the apparatus is returned to its base position a by stopping the supply of the pressurized gas via the pressurized gas line 2 with the valve 10 closed (by switching off the pressurized gas source 16 or by closing the pressurized gas line 2 with a valve). This causes the piston unit, which comprises the first piston 6, the second piston 5 and the connecting line 18, to move back to its base position a, which is shown in FIG. 2D. In the process, the piston unit is automatically brought into the base position a due to the restoring force of the spring element 7, in which the second piston 5 rests against the stop 21 of the front chamber 3 and the first piston 6 is pulled out of the dissolving chamber 4 at least to such an extent that the first piston 6 is located above the active substance access 12 and, in particular, above the opening in the wall of the dissolving chamber 4, as shown in FIG. 2D. In this base position a of the apparatus, the dissolving chamber 4 is again available for receiving a predetermined amount of the active substance 8 and in particular for receiving a predetermined number of balls or tablets of the active substance 8, and the apparatus can be used for a subsequent cycle.

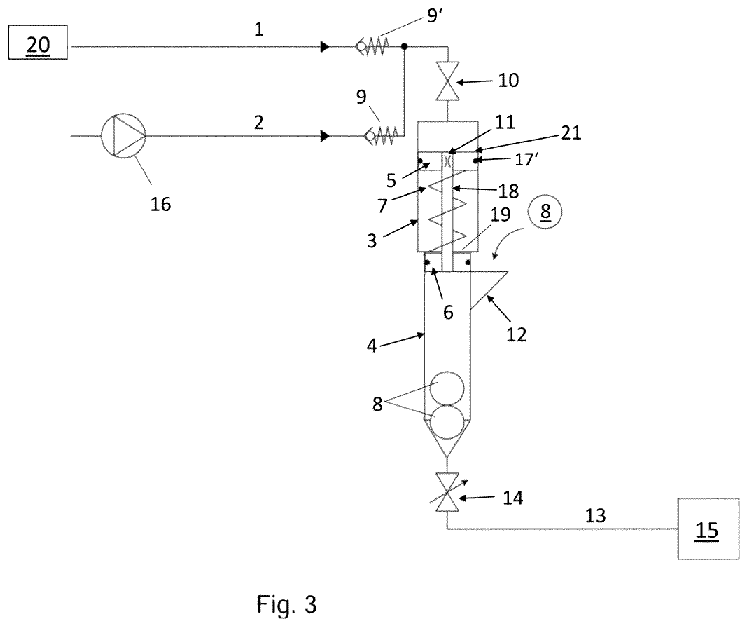

FIG. 3 shows a second embodiment of an apparatus according to the invention in the base position. This embodiment corresponds to the apparatus of FIG. 1, except for the arrangement of the compressed gas line 2, which in the embodiment of FIG. 3 does not open into the front chamber 3 but into the solvent line 1. In this case, a further check valve 9′ is arranged in the solvent line I to prevent compressed gas from flowing out of the compressed gas line 2 in the direction of the solvent supply 20. In this embodiment, the pressurized gas from the pressurized gas source 16 is directed into the solvent line 1 via the pressurized gas line 2 in order to press the active substance solution located in the dissolving chamber 4 into the discharge line 13 when the valve 10 in the solvent line 1 is open, after the active substance has been completely dissolved or mixed in the active substance solution. The embodiment of FIG. 3 is distinguished from the embodiment of FIG. 1 by a simpler structure of the front chamber 3.

The apparatus according to the invention enables a fast and complete dissolution and a homogeneous mixing of the active substance in the solvent, in particular due to the pressure and temperature of the solvent supplied via the solvent line 1. Furthermore, a precise dosing of a predefinable amount of the active substance 8 as well as the maintenance of a certain concentration of the active substance in the active substance solution is ensured, whereby the exact active substance concentration can be controlled in particular via the pressure of the solvent flow supplied through the solvent line 1. In this respect, the apparatus has a simple and compact design and does not require a motor control for transferring the apparatus from its base position a to its operating position b, and back. Features and advantages of the invention described with respect to the apparatus also relate to the method, and vice versa.

1-45. (canceled)

46. An apparatus for producing a solution from an active substance and a solvent and for supplying the solution to a beverage preparation machine, the apparatus comprising a dissolving chamber for receiving the active substance, a supply means for supplying a specific quantity of the active substance into the dissolving chamber, and a liquid line system with a solvent line connectable to a solvent supply for supplying the solvent and a discharge line connected to the dissolving chamber and connectable to the beverage preparation machine, wherein the apparatus further comprises a piston unit having a first piston insertable into the dissolving chamber, a second piston and a connecting line arranged between the first piston and the second piston.

47. The apparatus according to claim 46, wherein the first piston is movable between a base position, in which the first piston is withdrawn from the dissolving chamber, and an operating position, in which the first piston is located in the dissolving chamber wherein the connecting line connects the first piston and the second piston so that a movement of the second piston is transmitted to the first piston.

48. The apparatus according to claim 47, wherein the second piston is movably arranged in a front chamber, which is arranged upstream of the dissolving chamber and is in fluid-conducting communication with the dissolving chamber via the connecting line.

49. The apparatus according to claim 46, wherein the piston unit comprises a spring element, which is arranged between the first piston and the second piston and in particular around the connecting line.

50. The apparatus according to claim 49, wherein the spring element is supported on a support in the front chamber and extends between the support and the second piston, wherein the support is arranged or formed at a bottom of the front chamber.

51. The apparatus according to claim 49, wherein the spring element exerts a preload on the first piston in an unloaded state, which preload holds the first piston in a base position in which the first piston is pulled out of the dissolving chamber, whereby the first piston, upon a supply of solvent through the solvent line, is movable against a bias generated by the spring element from the base position into an operating position in which the first piston is located in the dissolving chamber.

52. The apparatus according to claim 48, wherein the front chamber has a stop which is arranged in the region of the upper end of the front chamber, wherein the second piston is bearing against the stop in an unloaded base position.

53. The apparatus according to claim 48, wherein the front chamber has a larger cross-sectional diameter than the dissolving chamber and/or wherein the second piston has a larger cross-sectional diameter than the first piston.

54. The apparatus according to claim 46, wherein the first piston and the second piston each contain at least one sealing element, the sealing element of the first piston is bearing against an inner wall of the dissolving chamber and the sealing element of the second piston is bearing against an inner wall of a front chamber.

55. The apparatus according to claim 46, wherein the supply means is arranged in an upper region or at an upper end of the dissolving chamber and is comprising an opening in a wall of the dissolving chamber and a dosing device which doses the active substance into the dissolving chamber.

56. The apparatus according to claim 55, wherein first piston is located in the dissolving chamber in an operating position to an extent that access from the opening into the dissolving chamber is blocked.

57. The apparatus according to claim 48, wherein the front chamber is connected to a pressurized gas line, wherein the pressurized gas line can be coupled to a pressurized gas source and opens into the front chamber or into the solvent line.

58. The apparatus according to claim 48, wherein the dissolving chamber and the front chamber extend in a vertically extending longitudinal direction.

59. The apparatus according to claim 46, wherein a shut-off valve and/or a control valve, and/or a pressure reducer is arranged in the solvent line and wherein a shut-off valve and/or a control valve is arranged in the discharge line.

60. The apparatus according to claim 48, wherein the front chamber is connected to a solvent supply which provides a solvent having a temperature between 40° C. and 100° C.

61. A beverage preparation machine comprising an apparatus according to claim 46, wherein the apparatus is coupled to a brewing device for brewing a hot beverage and/or to a device for frothing milk.

62. A method for producing and supplying an active substance solution to a beverage preparation machine, the method comprising:
producing a solution of an active substance and a solvent in a dissolving chamber by metering a specific quantity of an active substance into the dissolving chamber and then the solvent is fed into the dissolving chamber via a solvent line which can be connected to a solvent supply, whereby the active substance is dissolved in the solvent to form an active substance solution,
suppling the active substance solution to the beverage preparation machine via a discharge line connected to the dissolving chamber,
wherein after the active substance has been metered into the dissolving chamber, a first piston is introduced into the dissolving chamber and is pressed into the dissolving chamber by a pressure generated by the introduced solvent.

63. The method according to claim 62, wherein the solvent is introduced into the dissolving chamber by means of a connecting line extending through the first piston.

64. The method according to claim 63, wherein the first piston is coupled to a second piston via the connecting line, wherein the second piston is movably arranged in a front chamber, which is fluidly coupled to the dissolving chamber via the connecting line and the solvent line is connected to the front chamber to direct the solvent into the front chamber and into the dissolving chamber.

65. The method according to claim 64, wherein the pressure generated by the introduced solvent first acts on the second piston and is transmitted by the latter to the first piston, and wherein after generation of the active substance solution, the supply of solvent is first stopped and then the active substance solution is forced from the dissolving chamber into the discharge line by introducing a pressurized gas into the dissolving chamber.
